(19) United States
(12) Patent Application Publication
(10) Pub. No.: US 2004/0160974 A1
(43) Pub. Date: Aug. 19, 2004

(54) Method and system for rapid channel change within a transport stream

(76) Inventors: Christopher Jensen Read, San Diego, CA (US); David H. Bessel, Poway, CA (US)

Correspondence Address: WAGNER, MURABITO & HAO LLP, Third Floor, Two North Market Street, San Jose, CA, 95113, US

(21) Appl. No.: 10/366,781

(22) Filed: Feb. 13, 2003

(51) Int. Cl. H04L 12/28; H04J 3/04

(52) U.S. Cl. 370/431; 370/535

(57) ABSTRACT

Embodiments of the present invention relate to a method and system for changing programs in a digital transport stream carrying multiple channels which comprises receiving a digital television transport stream that has a plurality of multiplexed channels, de-multiplexing the plurality of channels, detecting I-frames of each channel and storing the most recent I-frame from each channel in a buffer. When a channel change is desired, the stored I-frame associated with the desired channel is obtained and decoded so that subordinate P-frames and B-frames in the desired channel can be immediately decoded in reference to the I-frame. By presenting the stored I-frame, there is no delay while waiting for a next transmitted I-frame in order to commence decoding and immediately presenting the selected channel to the display.

### FIELD OF THE INVENTION

Embodiments of the present invention relate to the field of digital television devices.

### BACKGROUND OF THE INVENTION

Digital television has begun to deliver a variety of information and entertainment to viewers. An immense amount of very high quality digital video is available via broadcast, cable, and direct satellite communication.

A feature of digital television broadcast and cable delivery is the necessity of compressing a high-quality video image into a narrow band-width for storage and transport as an encoded and multiplexed signal. Compression and multiplexing allow for a single transport stream, carrying many channels, or programs, of digital television programming, to fit in the limited RF bandwidth of a legally defined frequency in the public airwaves or into the bandwidth necessary to efficiently use a cable carrying many different digital transport streams.

The common television formats used throughout the world involve presenting a sequence of picture frames in a display. Each of the frames, when compressed, must still be able to recover all the visual information that is necessary to show the full, uncompressed, frame when presented in the ultimate display. The digital television standards in use allow for multiple compressed video programs with compressed audio as well as data channels.

It is noted here that the use of MPEG in this discussion refers to the various compatible compression standards of the Moving Pictures Experts Group which has promulgated several standards relating to compressed digital data delivery systems. One, known as MPEG-1, refers to ISO/IEC standards 11172 and is incorporated herein by reference as background. A second, known as MPEG-2, refers to ISO/IEC standards 13818 and is incorporated herein by reference as background. The delivery of coded video is commonly accomplished under ATSC (Advanced Television Standards Committee). A compressed digital video system is described in the ATSC digital television standard document A/53, also incorporated herein by reference as background.

A common video compression, or encoding, method is MPEG-2 which employs three different types of frames. The Intra-frame, or I-frame, incorporates all the information necessary to be decoded by itself. The other types of frames have to depend on an I-frame at some point. An I-frame provides the least amount of compression when encoded. The predictive frame, or P-frame, uses motion-adjusted differences from a previous reference frame to avoid redundant coding. The P-frame allows a greater amount of compression than the I-frame. The bi-directional frame, or B-frame, uses motion adjusted differences from both a previous and a future frame. The B-frame allows the greatest amount of compression when encoded.

It is noted that referencing incomplete frames to complete frames for decoding and decompression is not limited to MPEG compression schemes. Other encoding and compression techniques also use such referencing.

The three types of frames are all incorporated when a program is encoded under MPEG. When more than one program is multiplexed into a single transport stream, the coded packets that contain the transported fragments of the encoded frames, in most coding conventions, are sequenced with each other. A demultiplexer at a receiving device can separate out the programs and, when a particular program is desired, decode the program for presentation in a display.

Conventional art FIGS. 1A and 1B illustrate an exemplary system that transports, receives and presents digital television from either broadcast or digital cable. It is noted that the illustrated system is only representative of digital television reception and does not show the workings of any specific device or system. Transport stream 101, containing the information necessary to present more than one channel of television, including audio and data, is demultiplexed at 102. A channel desired by the user, is selected at 103. Because decoding, 105, presents a frame at a time to the display, the continuing stream of data packets that make up the demultiplexed transport stream are buffered in a memory device as illustrated at 104. It is noted here that the memory buffer illustrated here may be located in a logical position differently than that shown. Presentation to display 106 takes place when decoder 105 has decoded a presentable frame. Information not desired for display, 107, is typically discarded, a illustrated by “bit bucket” 108.

In traditional art FIG. 1B, the coded frames component of a transport stream is illustrated. A typical transport stream, such as shown at 120, contains, among other channels of information, channels of data packets which encode the frames of video sources. As noted above, multiple channels are encoded and multiplexed in a single digital transport stream. The time-equivalent frame sequence of more than one encoded and multiplexed channel is what is illustrated in FIG. 1B. Exemplary I-frame 121 is shown as an I-frame from one channel, channel A, as an example. Exemplary P-frame 122 is shown as a P-frame of channel A and exemplary P-frame 123 is shown as a B-frame of channel B. Exemplary I-frame 124 is an I-frame of channel B and P-frames 125 and 126 are exemplary P-frames of channels A and C, respectively. The other exemplary frames are P- and B-frames of other channels.

It is important to note that video information is not coded into a transport stream as frames but as coded data packets which represent the frames and that packets containing data from frames of different programs may be interleaved together. The data packets contain the information with which frames are constructed upon decoding. The illustrations of FIGS. 1A and 1B are shown to illuminate the background of digital television transmission.

It is also noted that the exemplary frames are shown in different sizes. P-frames are shown larger than B-frames and I-frames are shown as the largest. The difference in size is only for the sake of illustration of the relative compression ratios of the frames. An I-frame offers the least compression and a B-frame offers the most.

It is further noted that there is not a specific order to frames or to channels when multiplexed. The adaptive compression rate of MPEG-2 means that different parts of different programs compress more or fewer frames into a given amount of available bandwidth, depending on the instant video content. For this reason, there can be as much as several seconds between receiving of sequential I-frames of any particular channel. Because of the possible wait time for a first received I-frame after a channel switch by a user, a channel change causes a temporary delay before the new channel image can be displayed. Alternatively, some displays may present a brief amount of artifacts or other unwanted images as a result of incomplete decoding as a result of the channel switch.

This is because, in a single program video bit stream, an I-frame is inserted between groups of P- and B-frames. In a multiplexed transport stream, there may four to six, or more, programs multiplexed together. The next I-frame after a switch to a desired channel could lag two or more seconds behind the channel switch.

Television viewers perceive seamless, rapid switching from one channel to another to be an important television receiver characteristic. The necessity of referencing an I-frame when decoding digital television can make channel switching time long when compared to the switching times of traditional or analog television receivers. Thus, in some cases the viewer can be presented with a blank or otherwise non-program screen for several seconds when switching channels in a digital television coupled to the digital transport stream.

### SUMMARY OF THE INVENTION

Accordingly, embodiments of the present invention are directed to a novel method and system for enabling a rapid channel change in a digital transport stream that contains a number of channels by storing recent frame data for each channel, e.g., by storing the most recent transmitted I-frame in each channel, for instance.

Embodiments of the present invention relate to a method for changing programs in a transport stream which comprises receiving a digital television transport stream that has a plurality of multiplexed channels, de-multiplexing the plurality of channels, and storing the most recent I-frame, along with other information, from each channel in a buffer. When a channel change is desired, the stored I-frame associated with the desired channel is decoded so that subordinate P-frames and B-frames in the channel can be immediately decoded in reference to the stored I-frame. By immediately presenting the stored I-frame upon a channel change, there is no delay while waiting for a transmitted I-frame in order to commence decoding and immediately present the selected channel to the display.

In one embodiment, the method described herein consists of adding I-frame detectors to the demultiplexing circuitry, one for each video stream in the multiplex (combination of streams) and then buffering the video stream from that point. When a channel change request arrives and is found to be a switch to another program within the same transport stream, the video decoder can immediately start at the last known complete I-frame and begin decoding the new program, and the channel change is instantaneous. This creates an enhanced viewing experience for the user and is analogous to that perceived when using a conventional analog receiver.

In another embodiment, the method described herein demultiplexes and stores a series of frames comprising I-slices, such that one I-slice for each slice in the entire frame is stored. Then, when a channel change request arrives and is found to be a switch to another program within the same transport stream, the video decoder can immediately start decoding the last known I-slice containing frames, in some implementations faster than real-time reception, until a complete frame is obtained for display. As in other embodiments, the channel change is virtually instantaneous and creates the enhanced viewing experience of conventional analog video reception.

These and other objects and advantages of the present invention will become obvious to those of ordinary skill in the art after having read the following detailed description of the preferred embodiments which are illustrated in the various drawing figures.

### BRIEF DESCRIPTION OF THE DRAWINGS

The operation and components of this invention can be best visualized by reference to the drawings.

FIG. 1A (Conventional art) illustrates an exemplary digital television receiver.

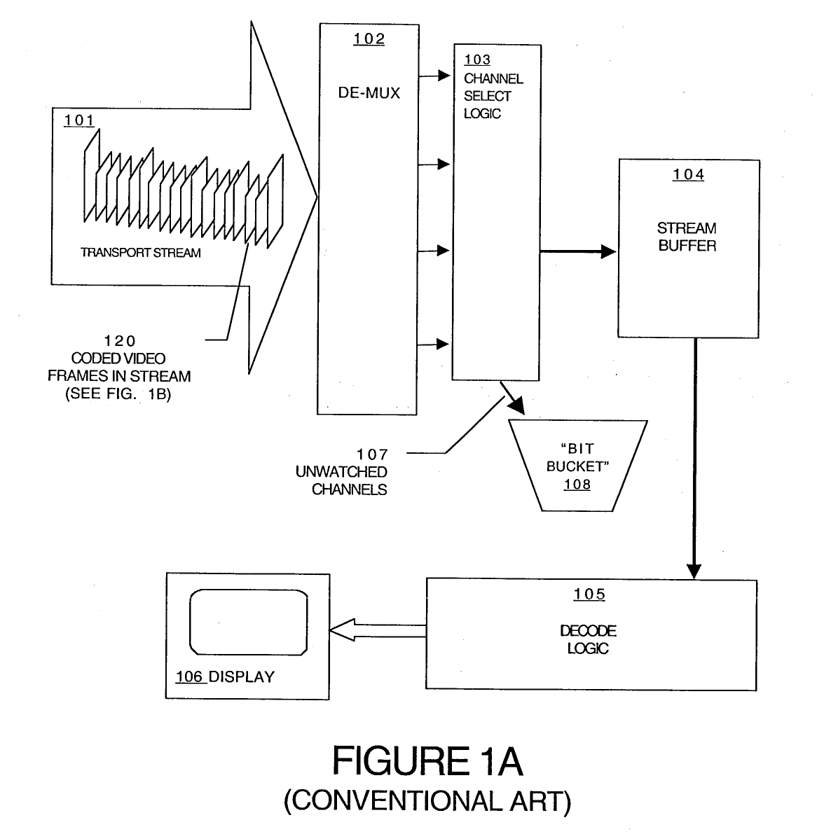

FIG. 1B (Conventional Art) illustrates an exemplary sequence of encoded multiple channel frames in a digital television transport stream.

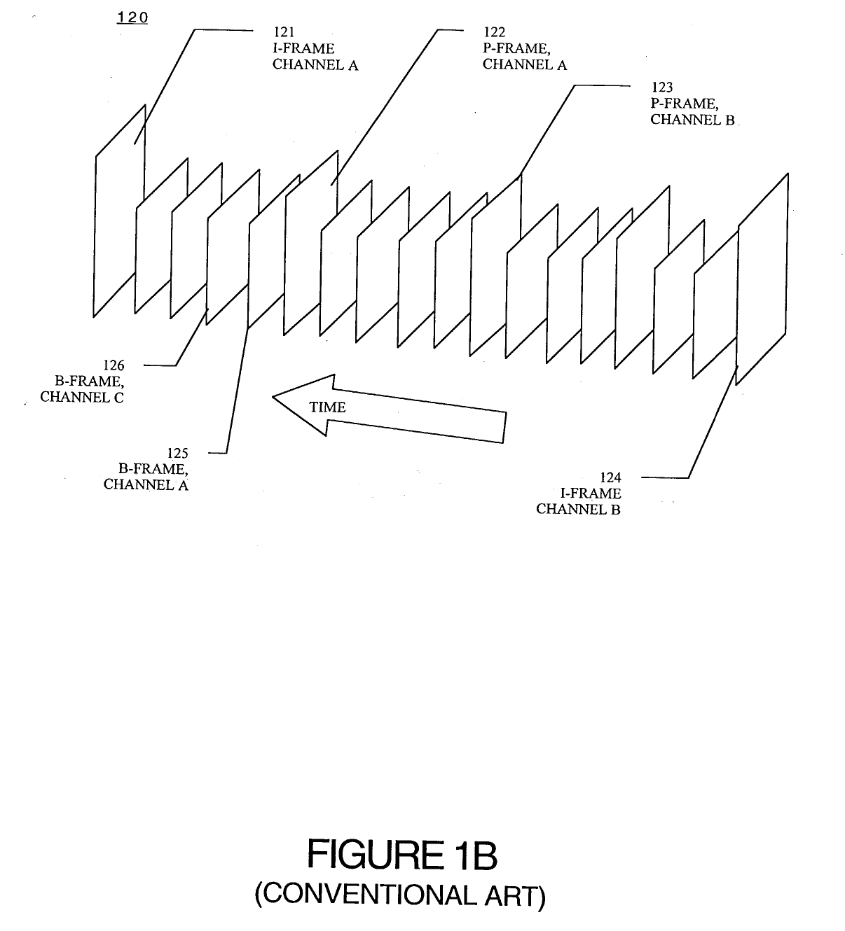

FIG. 2 illustrates a method for rapid channel change within a transport stream in accordance with an embodiment of the present invention.

FIG. 3 illustrates a system for rapid channel change in a transport stream in accordance with an embodiment of the present invention.

FIG. 4 illustrates a system for rapid channel change in a transport stream in accordance with an embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it should be understood by one of ordinary skill in the art that the present invention may be practiced without these specific details. In other instances, well-known methods, procedures, components, and circuits have not been described in detail so as not to unnecessarily obscure aspects of the present invention. At times, concepts disclosed in this discussion of embodiments of the present invention will be made more readily apparent by reference to the Figures.

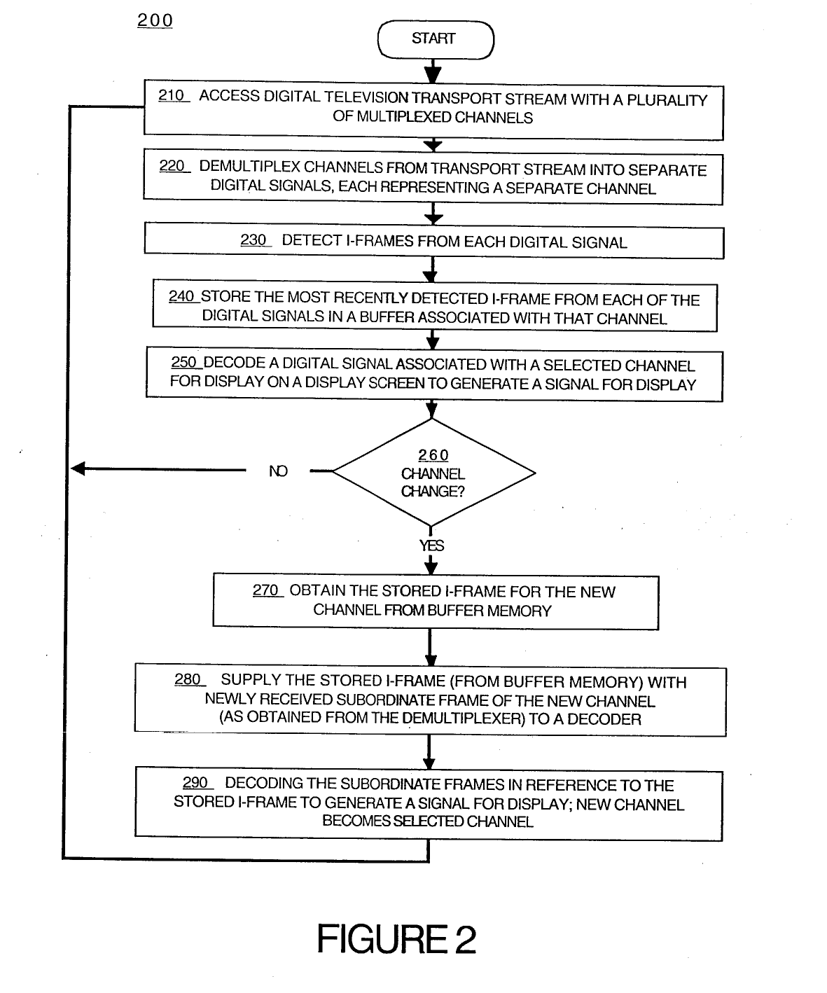

Embodiments of the present invention provide for rapid, seamless, changing of channels at the receiver within a digital transport stream. It is noted that, as used herein, “seamless” implies an apparently instantaneous channel change, where there is no noticeable non-program screen displayed to the viewer. FIG. 2 illustrates, in block flow form, a method for accomplishing rapid channel change in accordance with an embodiment of the present invention.

It is noted that, in broadcast or digital cable TV implementations, there are commonly several different programs contained within a single RF bitstream, or digital transport stream. One component of fast channel switching is switching between different programs of a single transport stream with little or no perceptible delay in presenting the new channel.

Before any channel change can take effect and be displayed, an I-frame is decoded in the new program. Knowing where the last I-frame occurred, and buffering the video bitstream back to that last I-frame, as described in embodiments of the present invention, can allow immediate decoding of the new program to facilitate fast channel changing or in a digital transport stream.

FIG. 2 illustrates, in block flow form, a method for implementing a rapid and seamless channel change within a digital television transport stream. Method 200 starts at step 210 with accessing a digital television transport stream that contains more than one encoded and multiplexed digital television channels. The channels are demultiplexed and decoded and separated at step 220. I-frames are also detected in each digital channel, step 230, then memory buffers store a recent I-frame (or groups of recent frames) from each channel at step 240. In this embodiment, the buffer stores the most recent I-frame (or frames) and continually refreshes it as each new I-frame is received. In other embodiments of the present invention, other storage can store an entire bit stream and the I-frame is available on decoding. Alternatively, at step 240, more than just the I-frames can be stored for each channel. For instance, the method can store the last B, I and P-frames encountered for a particular channel. The incoming digital stream, containing the three frame types, is decoded into a displayable signal at step 250.

When the user desires a channel change, it is made at 260. If the newly desired channel is within the currently received transport stream, the most recent stored I-frame from the desired channel is obtained from the memory at step 270. At step 280, it is decoded and sent to the display. The I-frame is also immediately available to the decoder for further decoding, at step 290, of the subordinate frames, e.g., the P- and B-frames, that are currently and continually being received in real time in the transport stream. Decoding of the received and demultiplexed channel then continues normally and the decoded television program is presented to the display as the new current channel.

When no channel change is desired, at step 260, the system continues displaying the current channel and waits for subsequent channel changes. It is noted that the audio information normally associated with the television program is decoded and presented normally by whatever means is appropriate to the system involved and any well-known method can be used.

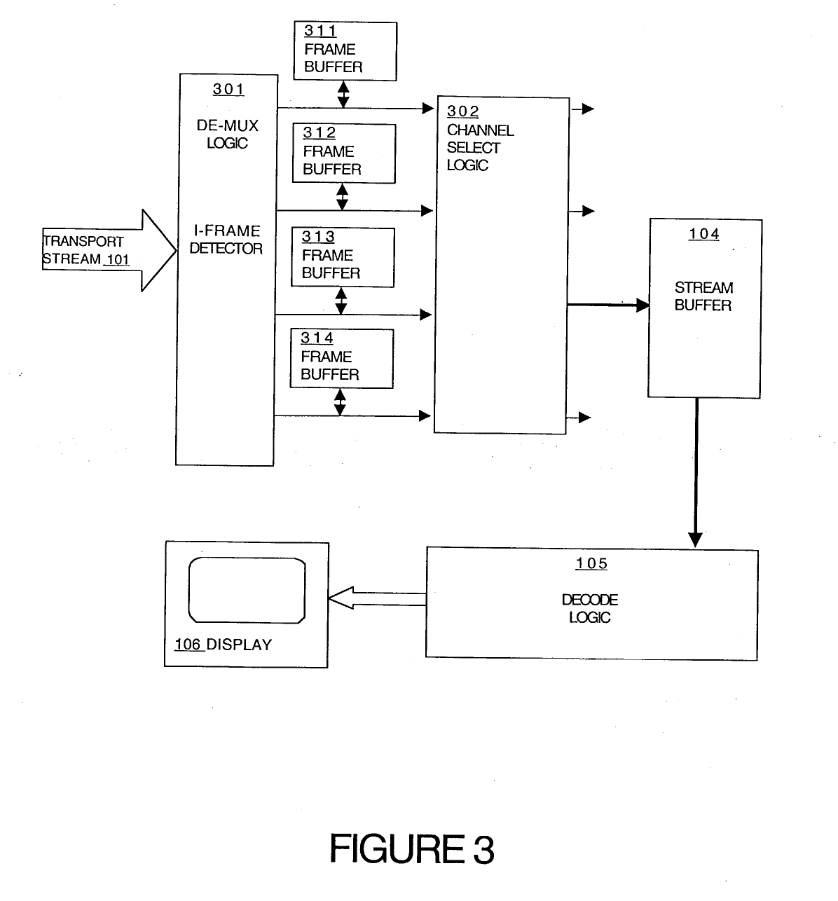

FIG. 3 illustrates a digital system that accomplishes a rapid channel change within the transport stream as described in 200. Transport stream 101 is received and demultiplexed into individual channels in demultiplex (de-mux) logic, 301 which also, in this embodiment of the present invention, contains an I-frame detector. One demultiplexed, each channel is sent to a separate memory buffer, 311-314, where the most recent I-frame is stored for subsequent use. Alternatively, the most recent group of I-frames or B, P, and I-frames can be stored in each buffer.

The method proposed in this embodiment of the present invention comprises using I-frame detectors in the de-mux circuitry, 301, one for each video stream or channel in the multiplex (combination of streams) and then buffering the video stream from that point. When a channel change request is made and is found to be a switch to another program within the same transport stream, the video decoder can immediately start at the last known complete I-frame (from the buffer) supplied to the decoder, 105, and begin decoding the new program, and the channel change is instantaneous.

When channel changing occurs at channel change logic block 302, in FIG. 3, both the incoming stream and the content of the channel-associated memory buffer are immediately available to the decoding logic, 105, and the stream buffer, 104. Since complete frames are required for presentation to display 106, a stream buffer, 104, is required for storing the incoming data stream for decoding into presentable frames. In one embodiment, each channel represents approximately 4 Mb/sec of data. Therefore, each respective buffer is on the order of 1 MB in size to cache the last I-frame of data.

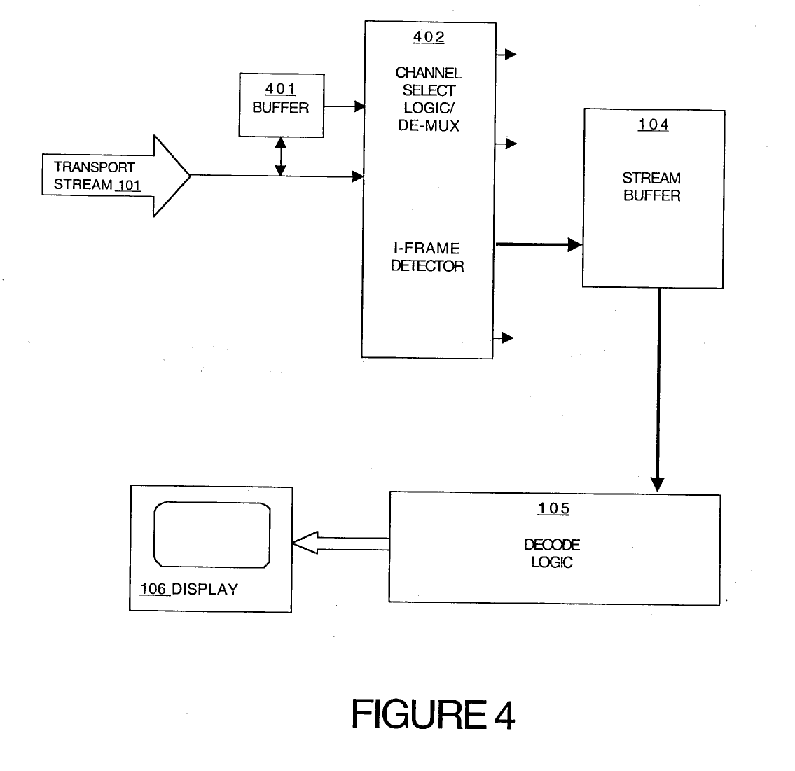

FIG. 4 illustrates another embodiment of the present invention. Here, demultiplexing occurs after a channel is selected for viewing. In the scenario shown in this embodiment of the present invention, the incoming digital transport stream, 101, is buffered in stream buffer 401 which maintains the most recent few seconds of the coded incoming stream. When a channel change is made, the I-frame detector of channel select/demultiplex logic 402 quickly selects the most recent I-frame of the desired channel that is stored in buffer 401 and sends it to stream buffer 104 and decode logic 105. Subsequent demultiplexing, buffering and decoding then takes place normally in the incoming transport stream.

Other embodiments of the present invention are able to demultiplex and decode channels in the incoming transport stream by other methods not discussed in detail here. However, when changing channels within a transport stream, the various embodiments of the present invention are able to immediately commence presentation of the selected channel's programming by presenting a stored I-frame from which P-frame and B-frame decoding can commence. In this way, the delays in presentation brought on by a channel change are reduced if not eliminated.

Still other embodiments of the present invention are able to demultiplex and decode channels in an incoming transport stream that comprises I-slices. An I-slice contains information necessary to the decoding of other slices of the video stream of a transmitted channel and the behavior of these embodiments is much like that of those embodiments which decode and store an I-frame for decoding reference by subordinate frames. In this embodiment, a grouping of I-slices is decoded and stored sufficient to provide immediate decoding of the subsequent received data stream. As in the previously described embodiments, this embodiment provides an immediate and seamless channel change when selecting another channel within the present transport stream.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

We claim:

1. A method for changing channels of a digital television transport stream, comprising:
accessing said digital television transport stream comprising a plurality of multiplexed channels;
detecting and storing a recent video data from a first channel in a buffer while displaying a second channel;
selecting said first channel for display;
retrieving and decoding said stored video data associated with said first channel;
decoding subordinate video data of said first channel in said received transport stream in reference to said stored video data; and
based on said stored video data and said subordinate video data, presenting said channel to a display.

2. The method for changing channels in a digital transport stream described in claim 1, wherein said stored video data comprises an I-frame.

3. The method for changing channels in a digital transport stream described in claim 2, wherein said subordinate video data comprises subordinate video frames.

4. The method for changing channels in a digital transport stream described in claim 1, Wherein said stored video data comprises a frame comprising an I-slice.

5. The method for changing channels in a digital transport stream described in claim 1, wherein said stored video data comprises a plurality of frames comprising one or more I-slices

6. The method for changing channels in a digital transport stream described in claim 1, wherein said accessing said digital television transport stream comprises demultiplexing said plurality of multiplexed channels.

7. The method for changing channels in a digital transport stream described in claim 1, wherein said selecting said first channel comprises demultiplexing said plurality of multiplexed channels.

8. The method for changing channels in a digital transport stream described in claim 1, wherein said storing a recent video data comprises continually storing the most recent I-frame of said first channel.

9. The method for changing channels in a digital transport stream described in claim 8, wherein said storing the most recent I-frame comprises continually storing the most recent encoded bit stream of each of said plurality of channels in said transport stream in respective buffers.

10. The method for changing channels in a digital transport stream described in claim 8, wherein said storing the most recent I-frame comprises continually storing the most recent I-frame of each of said demultiplexed channels from said transport stream in a separate buffer.

11. The method for changing channels in a digital transport stream described in claim 1, wherein said selecting said first channel results in a seamless channel change.

12. The method for changing channels in a digital transport stream described in claim 1, wherein said selecting said channel results in an apparently instantaneous channel change.

13. A display system for seamless channel change within channels of a digital transport stream, comprising:
a demultiplexing device for separating a digital television channel from said digital transport stream comprising a plurality of multiplexed channels;
a memory device for storing a recent frame of said digital television channel;
a channel selecting device for selecting said digital television channel from among said plurality of multiplexed channels; and
a decoding device for decoding said digital television channel for presentation in a display, wherein said stored frame is supplied to said decoding device in response to a channel change for decoding to display said digital television channel.

14. The system described in claim 13, further comprising an I-frame detector.

15. The system described in claim 14, wherein said stored frame is an I-frame.

16. The system described in claim 15, wherein said decoding device decodes subordinate frames of said digital television channel in reference to said stored I-frame to display said digital television channel.

17. The system described in claim 13, wherein said memory device stores a transport stream bit sequence comprising said plurality of multiplexed channels.

18. The system described in claim 13, wherein said memory device comprises a plurality of memory buffers for storing a respective recent frame from each of a plurality of demultiplexed digital television channels.

19. The system described in claim 18, wherein said respective recent frames are I-frames.

20. The system described in claim 18, wherein said decoding device decodes subordinate frames of said digital television channel in reference to said stored frame.

21. A digital receiver comprising:
a demultiplexer for separating a digital transport stream into a plurality of individual digital channels wherein said digital transport stream comprises a plurality of multiplexed digital channels;
a plurality of buffers, each buffer for storing a recent frame associated with an individual digital channel;
a decoder for decoding digital data associated with a channel for display on a display screen; and
logic, responsive to a channel change, for supplying said decoder with a stored frame from a buffer associated with a selected channel, said logic then supplying said decoder with digital data associated with said selected channel from said demultiplexer.

22. A digital receiver as described in claim 21 wherein each buffer stores an I-frame associated with an individual digital channel and further comprising an I-frame detector coupled to said demultiplexer for detecting I-frames in said plurality of individual digital channels.

23. A digital receiver as described in claim 21 wherein said digital data associated with said selected channel comprise subordinate frames of said selected channel and wherein said decoder decodes said subordinate frames in reference to said stored frame.

24. A digital receiver as described in claim 23 wherein said subordinate frames are P-frames and B-frames.

25. A digital receiver as described in claim 21 wherein each buffer stores a plurality of recent frames associated with an individual digital channel and wherein one of said plurality of recent frames is an I-frame.

26. A digital receiver as described in claim 21 wherein said decoder is an MPEG (Motion Pictures Exert Group) compatible digital decoder.

27. A digital receiver as described in claim 21 further comprising a stream buffer and wherein said digital data associated with said selected channel is buffered by said stream buffer before being supplied to said decoder.

28. A digital receiver as described in claim 21 wherein said plurality of buffers are implemented as individual address spaces of a single memory device.

29. A method of decoding information for display on a display screen comprising:
a) demultiplexing a digital transport stream into a plurality of individual digital channel signals;
b) storing a recent frame associated with each individual digital channel signal of said plurality of individual digital channel signals;
c) generating a signal representing a first digital channel for supply to said display screen by decoding a digital channel signal associated with a first digital channel;
d) responsive to a channel change from said first digital channel to a second digital channel, performing the following:
d1) obtaining a stored recent frame associated with said second digital channel; and
d2) generating a signal representing said second digital channel for supply to said display screen by decoding a digital channel signal associated with said second digital channel in reference to said stored recent frame of said d1).

30. A method as described in claim 29 wherein said recent frame associated with each individual digital channel signal is an I-frame and further comprising, in response to said a), detecting I-frames within said plurality of individual digital channel signals.

31. A method as described in claim 29 wherein said stored recent frame associated with said second digital channel is stored before said channel change.

32. A method as described in claim 29 wherein said b) is performed using a plurality of individual buffer memories, each buffer memory for storing a respective recent frame.
